(19) United States
(12) Patent Application Publication
(10) Pub. No.: US 2007/0201491 A1
(43) Pub. Date: Aug. 30, 2007

(54) System and method for synchronizing serial digital interfaces over packet data networks

(76) Inventor: Ron Kapon, Kiryat-Ono (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 11/363,280

(22) Filed: Feb. 28, 2006

(51) Int. Cl. H04L 12/56

(52) U.S. Cl. 370/395.62

(57) ABSTRACT

A system for synchronizing circuit interfaces for transmitting a serial bit stream in the form of data packets over a packet data network (PDN). The system includes a transmitter side device responsible to receive the data packets via a serial interface comprising data from an input serial line according to an input clock and output the data into a PDN. The system also includes a receiver side device responsible to receive the data packets from the PDN and to release the data packets into an output serial line, according to the difference between the input clock and an output clock (C_{OUT}), such that small input clock deviations can be detected and adjusted for upon releasing the output bits into the output serial line.

### FIELD OF THE INVENTION

The present invention relates to a system for packet data networks, and more particularly, to a method and devices for synchronizing serial data interfaces over packet data networks.

### BACKGROUND OF THE INVENTION

With the growing implementation of fast packet data networks (PDN's), such as Local Area Networks (LAN's), Wireless Local Area Networks (WLAN's) and Metropolitan Area Networks (MAN's), there is a demand to transport circuit switching services over these PDN's. The circuit switch service requires synchronizing the two end clocks, as well as the passing of the data (bit stream). The requirement for synchronization is defined in G.823, G.824, G.811 and G.812 standards.

There is a demand to transfer legacy services, such as Time Division Multiplexing (TDM), over the new high-speed packet switching networks.

A jitter buffer is a hardware device or software process that eliminates jitter caused by transmission delays over a data network. As the jitter buffer receives voice packets, it adds small amounts of delay to the packets so that all of the packets appear to have been received without delays. Voice signals are sequential by nature (i.e., they must be played back in the order in which they were sent) and the jitter buffer ensures that the received packets are in the correct order. Without a jitter buffer to smooth the transmission, data can be lost, resulting in choppy audio signals.

There are two types of jitter buffers: dynamic and static. A static jitter buffer is hardware-based and configured by the manufacturer. A software-based jitter buffer is called a dynamic jitter buffer and can be configured by the system or network administrator.

The major concern of both service providers and enterprises when migrating to data networks is the need to maintain the same service quality as that offered by their current circuit-switched network. When a Real-Time Transport Protocol (RTP) voice packet reaches a voice gateway, the preparation and conversion required for transmitting over the public switch telephone network (PSTN) can be broken down into three major steps; storage, sorting and decoding/playing. PSTN refers to the international telephone system that uses copper wires to carry analog voice data.

Mitigating the effect of jitter on voice communication is one of the major challenges facing TDM/data network service vendors. Removing jitter requires collecting packets and storing them long enough to allow the slowest packets to arrive in order to be played in the correct sequence. The storage area used by those devices is known as the “Jitter Buffer.” The network device increases the delay as it waits for the slowest packet to arrive.

In order to achieve voice quality, the vendor must balance the need to minimize delay with the need to remove jitter. The bigger the buffer, the more delay, but if the buffer is too small, then voice quality can be compromised. Therefore, the ideal solution would adapt to the characteristics of the network, storing only the required amount of buffered voice traffic. This feature is known as “Jitter Buffer Management.”

Most vendors use one of two methods to manage the size of the jitter buffer. In one method packet time variations in the jitter buffer are measured over a period of time and the buffer size is incrementally adapted to match the calculated jitter. The number of packets that arrive too late to be processed are counted and compared to the number of packets that were successfully processed. This ratio is then used to adjust the jitter buffer to target a predetermined allowable late packet ratio.

As the data is stored, it must also be sorted into the original sequence to accurately reproduce the original audio. RTP and other protocols use sequence numbers to reassemble the data according to its original order. Packets can arrive in any sequence, at any time or not at all. The Jitter Buffer Manager sorts the voice frames according to a sequence number supplied in the RTP packet. The manager leaves open slots for those packets that have not yet arrived. The voice sampling size used by the voice coder determines the size of the slots. The Jitter Buffer Manager also determines the average holding time of a packet and thus the jitter buffer size.

A digital signal transmission rate of 2.048 million bits-per-second (Mbps) is used on E1/T1 communications lines within a phone network. E1/T1 is a phone line connection that can transfer data at 1.536 Mbps. It is frequently used to connect LAN's to the Internet.

VoIP is a high level protocol having a specific notation for voice and phone calls, while TDMoIP/TDMoE (TDM over IP and TDM over Ethernet) relates to a lower level of the 7-layer Open System. Interconnection (OSI) stack, where E1, T1 or other TDM trunk is relayed via a packet data network.

FIG. 1 is a prior art example of an application of TDM over packet service 100, where a cellular base transceiver station (BTS) 150 is connected to the central Private Branch Exchange (PBX) 110, or Public switched telephone networks (PSTN), using a packet data network 130, such as fast Ethernet. TDM is a digital multiplexing technique whereby each signal is sent and received at a fixed time slot in a series of time slots. The transmitter 120 and receiver 140 must be time-synchronized. Public switched telephone networks (PSTN's) typically use TDM.

Currently there are two approaches to handle the synchronization problem. The first is accurate clock transmission, wherein both sides use very accurate clocks. The measurements of the circuit interface clock are passed continuously between to the two ends (in or out band) and the clock correction is applied on the other side. This solution is very accurate, but requires fairly expensive hardware in the form of the accurate clock.

The second current solution involves high-resolution measurement, which is based on the measurement of the time difference between the packet arrivals on the PDN receiver. The receiver computes the clock of the other side and applies the correction. Since a very accurate measurement on the arrival time is required, dedicated custom hardware is required. Moreover, the accuracy of the clock recovery is limited in some network scenarios.

Thus, it would be highly advantageous to have a method and a system for PDN's that provide a simple software and hardware solution to achieve precision economically.

### SUMMARY OF THE INVENTION

Accordingly, it is a principal object of the present invention to provide a simple software and hardware solution to achieve precision. The software provides a simple means for clock accuracy and clock adjustment.

It is a further object of the present invention to provide a system which requires minimal hardware.

It is another object of the present invention to provide a system which is more economical.

A system is disclosed for synchronizing circuit interfaces for transmitting a serial bit stream in the form of data packets over a packet data network (PDN). The system includes a transmitter side device responsible to receive the data packets via a serial interface comprising data from an input serial line according to an input clock, and the system outputs the data into a PDN.

The transmitter side device includes an input line interface unit (ILIU) responsible to terminate the input serial line and to retrieve both the data packets and the readings of the input clock into the transmitter side device and a packetizing unit responsible to group the bit stream received by the ILIU into fixed size packets and release the fixed size packets into the output queue.

The transmitter side device also includes an output queue (OUTQ) responsible to store the fixed size packets waiting for transmission to the PDN an independent clock C_{IND} operating outside of the valid range of the input clock and responsible to control the transmission of the fixed size packets from the OUTQ to the PDN using the Input Ethernet Controller (IEC) and an IEC responsible to transmit the fixed size packets to the PDN.

The system also includes a receiver side device responsible to receive the data packets from the PDN and to release the data packets into an output serial line, according to the difference between the input clock and an output clock (C_{OUT}).

The receiver side device includes an output Ethernet controller responsible to receive the packets from the PDN and to pass on the packets into the jitter buffer queue (JBQ), a JBQ responsible to store the packets received from the PDN before sending the packets to the output serial line, a serializer responsible to receive the packets from the JBQ and output the packets as a bit stream into the OLIU using C_{OUT} generated by the Clock Generator (CG) to output bits into the input line interface unit (OLIU) and an internal buffer clock (C_{B}) used as a reference for the CG to generate the value of C_{OUT}.

The receiver side device also includes a clock recovery algorithm (CRA) in the form of a control loop responsible to calculate the difference between C_{IN} and C_{OUT} based on the ability to measure a small deviation, such as 15 parts per billion (PPB) within seconds, based on the transmission using the C_{IND} in the transmitter side device. The receiver side device also includes a CG responsible to generate the C_{OUT} based on internal reference C_{B} and the CRA calculation, wherein CG resolution determines the C_{OUT} accuracy resolution of the 15 PPB. The receiver side device also includes an OLIU responsible to transmit the bit stream generated by the SER into the output serial line, such that small input clock deviations can be detected and adjusted for upon releasing the output bits into the output serial line.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a prior art example of an application of TDM over packet service where a cellular base station is connected to the central PBX;

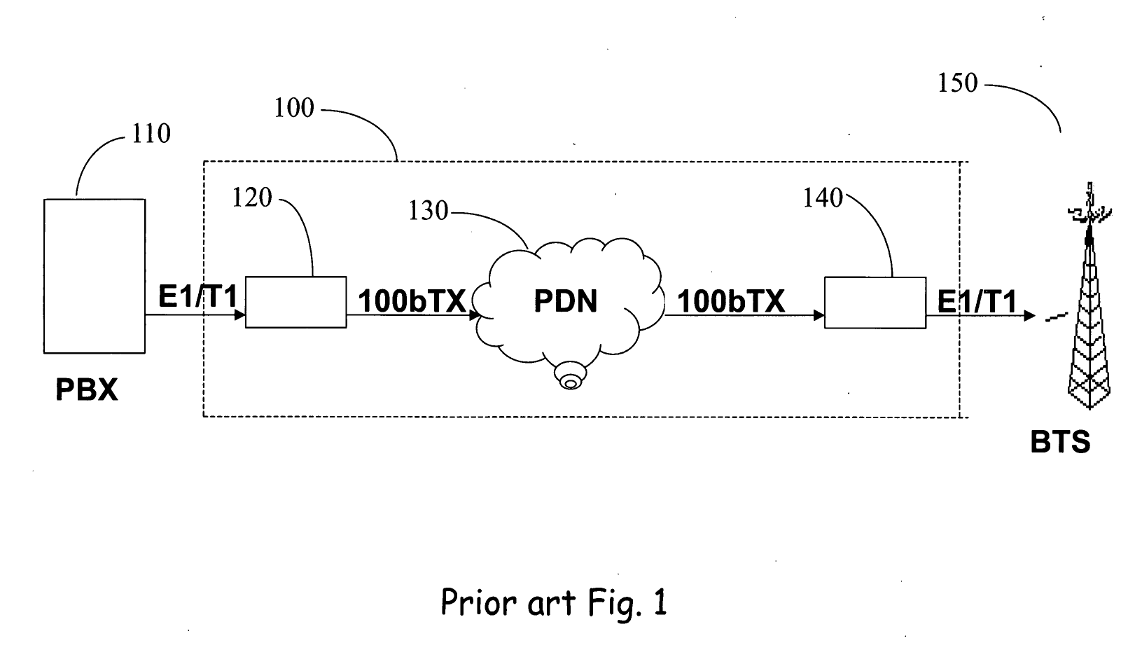

FIG. 2 is a schematic block diagram illustrating synchronization method architecture, constructed in accordance with the principles of the present invention;

FIG. 3 is a graph illustrating the difference between standard transmission architecture and the independent transmission technique used in accordance with the principles of the present invention; and

FIG. 4 is a detailed schematic block diagram illustrating synchronization method architecture, constructed in accordance with the principles of the present invention.

### DETAILED DESCRIPTION OF AN EXEMPLARY EMBODIMENT

The principles and operation of a method and a system according to the present invention may be better understood with reference to the drawings and the accompanying description, it being understood that these drawings are given for illustrative purposes only and are not meant to be limiting.

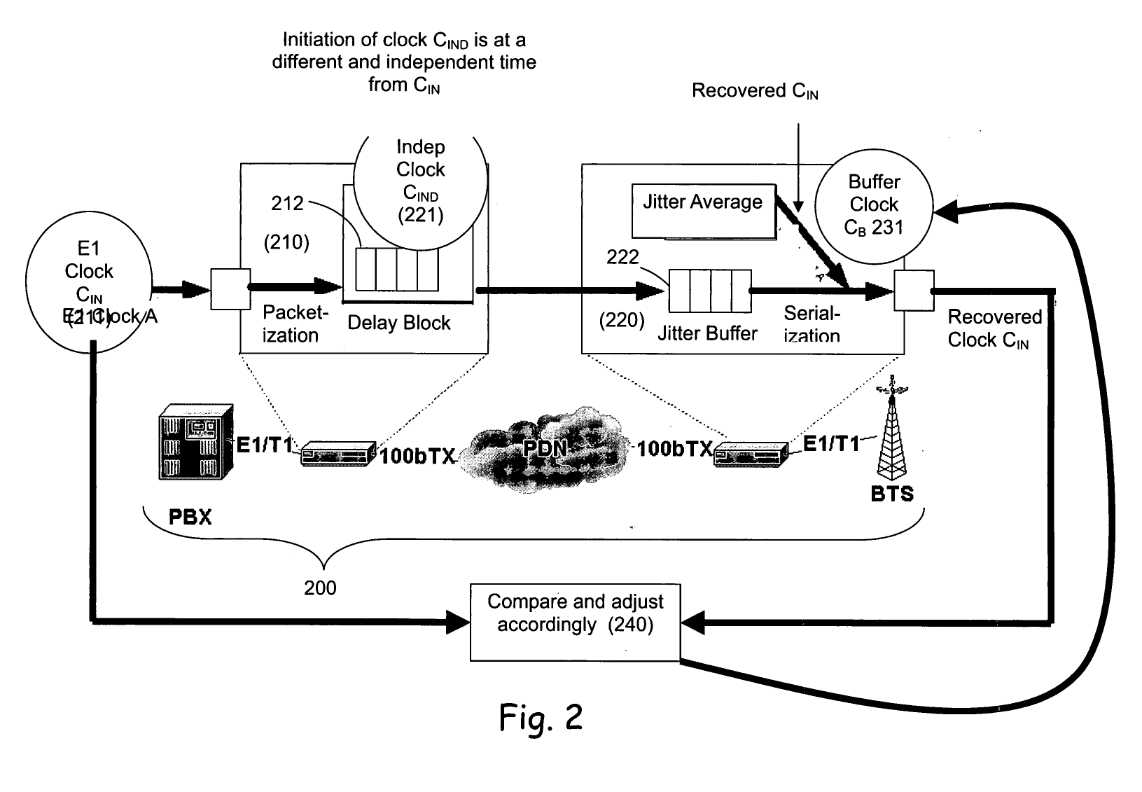

FIG. 2 is a general schematic block diagram illustrating synchronization method architecture, constructed in accordance with the principles of the present invention. A digitized E1 signal enters transmitter side device 210 of a TDMoIP/TDMoE system 200, and is transmitted according to an input clock C_{IN} 211, where it first undergoes packetization into a delay block 212. The architecture of the present invention uses a sliding window that is based on a second, independent clock C_{IND} 221, which runs on a different frequency from clock C_{IN} 211, e.g., at ˜1000 parts/million (PPM) offset. Clock C_{IND} 221 is used to delay the packets on transmitter side device 210 in delay block 212. On the receiver side device 220 of TDMoIP/TDMoE system 200, a simple averaging by a jitter buffer 222 is used.

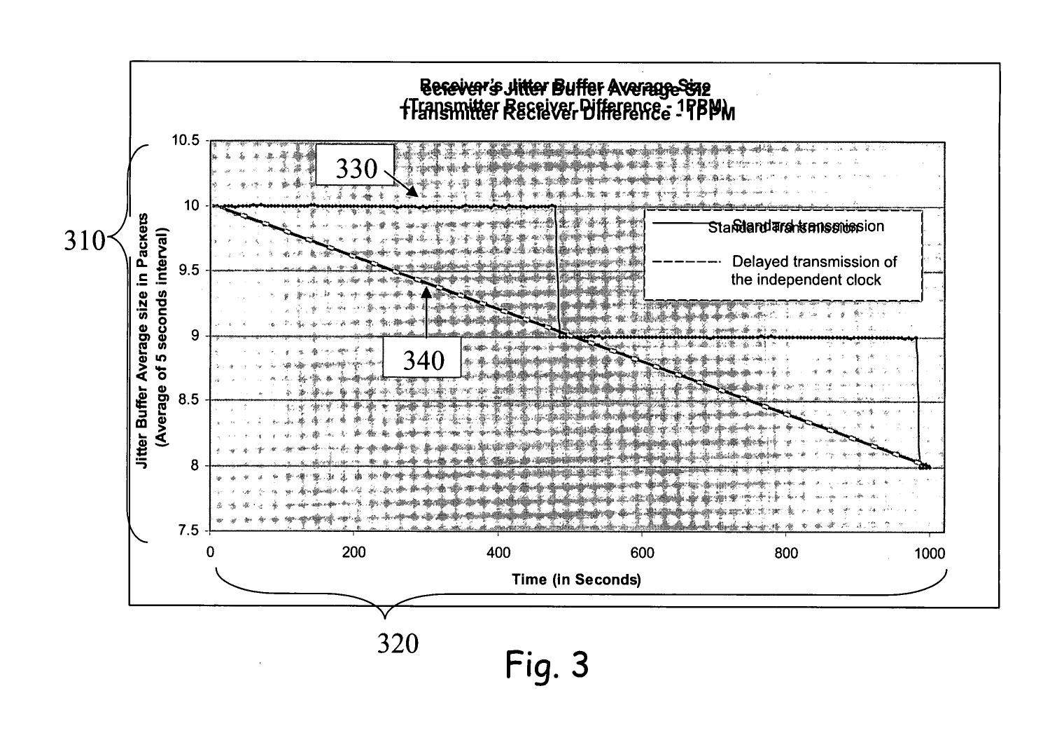

In prior art methods, either a highly accurate and expensive clock is used, or expensive dedicated hardware measures the exact time of the packet arrivals. If both of these expensive solutions cannot be used, the deviation between the input and the output clock can be measured only over a long period of time (FIG. 3 below illustrates a simulation in which 1 PPM deviation can be detected in few hundredths of a second). When a new delay block is added to the system a small clock deviation can be easily detected within a short period without the need for additional hardware such as an accurate clock or accurate packet arrival timestamping. FIG. 3 illustrates that the same 1 PPM deviation between the input and the output clock can be detected in a matter of 5 seconds.

Using this method, small clock deviations can be detected within a few seconds, e.g. 0.015 PPM within 5 seconds. C_{IN} 211 can vary up to 50 PPM according to the standard. The system is required to adapt to these changes. If C_{IN} 211 changes, then the buffer clock C_{B} 231 should be changed accordingly 240.

FIG. 3 is a graph illustrating the difference between standard transmission architecture 330 having no delay block and the independent transmission technique 340 that does have a delay block, used in accordance with the principles of the present invention. The jitter buffer average packet size 310, for an average interval of 5 seconds, is plotted against the receiver's jitter buffer average size 320, for a transmitter/receiver difference of 1 PPM. The graph displays simulation results of the two transmission systems. The standard system transmits packets according to the input clock rate. The independent transmission system uses an independent clock with 1000 PPM deviations. The graph shows that although over long periods (e.g., 1000 seconds) the receiver can recover the transmitter input clock. Over shorter periods, the standard system cannot detect any clock deviation. By contrast, using an independent clock, deviation can be detected within a few seconds.

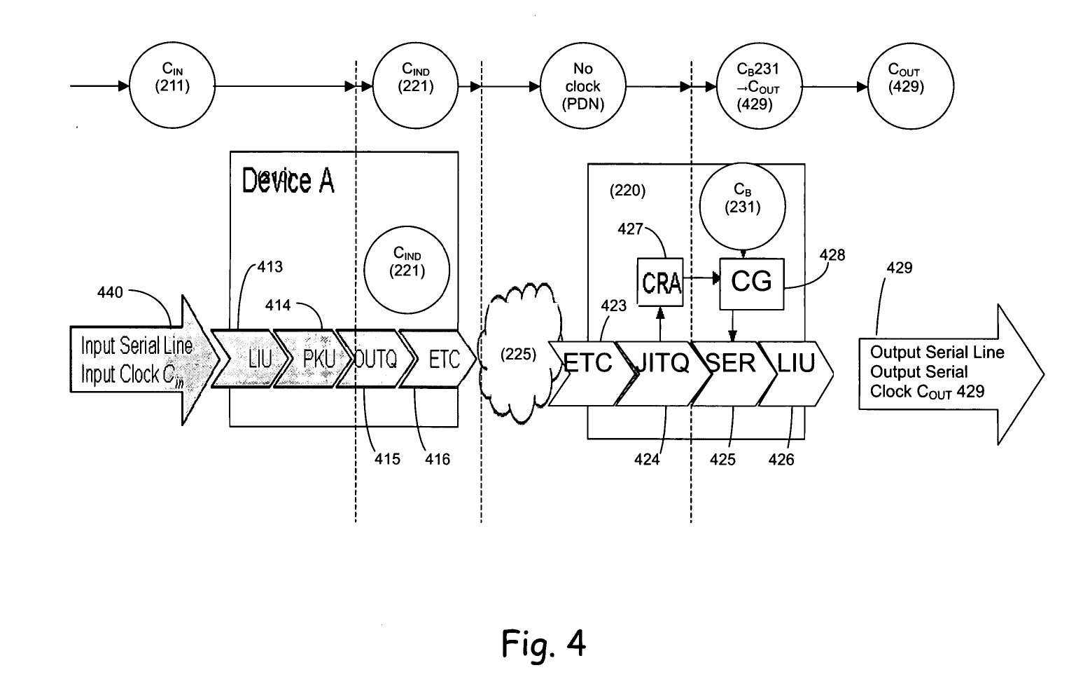

FIG. 4 is a detailed schematic block diagram illustrating synchronization method architecture, constructed in accordance with the principles of the present invention. The system provided by the present invention comprises two main units. The transmitter side device 210 is responsible to receive packets via a serial interface comprising data from input serial line 440 (e.g, E1 or T1 trunks) according to C_{IN} 211, and output the data into a packet data network (PDN) 225. Receiver side device 220 is responsible to receive packets from PDN 225 and to release the data into the output serial line 429, according to C_{IN} 211 and output clock (C_{OUT}) 429.

The quality of the solution is determined by the difference between the input and output clocks. The Unit Interval (UI) is the measurement unit defined by the standard G.823 for the clock quality.

Transmitter side device 210 has five (5) components:
Input Line Interface Unit (LIU) 413;
Packetizing unit (PKU) 414;
Output Queue (OUTQ) 415;
Independent Clock (C_{IND}) 221; and
Input Ethernet Controller (IETC) 416.

The input line interface unit (ILIU) 413 is responsible to terminate input serial line 440 and to retrieve both the data and the readings of C_{IN} 211 into transmitter side device 210. The packetizing unit (PKU) 414 is responsible to group the bit stream received by ILIU 413 into fixed size packets, and release the packets into the output queue 415. The output queue (OUTQ) 415 is responsible to store the packets waiting for transmission to PDN 225. The independent clock (C_{IND}) 221 is an independent clock, operating outside of the valid range. For example C_{IND} 221 operates at +1000 PPM of C_{IN} 211, while C_{IN} 211 is +/−50 PPM of the serial input line nominal value. Independent clock C_{IND} 221 controls the transmission of the packets from OUTQ 415 to PDN 225 using Input Ethernet Controller (IETC) 416. IETC 416 represents the PDN line interface unit that is responsible to transmit packets to PDN 225.

Receiver side device 220 has seven (7) components:
Output Ethernet Controller (OETC) 423;
Jitter Buffer Queue (JBT) 424;
Serializer (SER) 425;
Buffer Clock B (C_{B}) 231;
Clock Recovery Algorithm (CRA) 427;
Clock Generator (CG) 428; and
Output Line interface Unit (OLIU) 426.

The Output Ethernet Controller (OETC) 423 is responsible to receive the packets from PDN 225 and to pass on the packets into the jitter buffer queue (JBQ) 424. JBQ 424 is responsible to store the packets received from PDN 225 before sending them to output serial line 429. JBQ 424 is used to overcome several data network problems, such as packet arrival disorder, variable delay, etc. JBQ 424 is also used by CRA 427 to calculate the difference between C_{IN} and C_{OUT}. The Serializer (SER) 425 is responsible to receive the data from the JBQ 424 and output it as a bit stream into the OLIU 426. SER 425 uses C_{OUT} 429 generated by the Clock Generator (CG) 428 to output bits into OLIU 426. Receiver side device 220 also has an internal clock, Buffer Clock B (C_{B}), which is used as a reference for CG 428 in order to generate the value of C_{OUT} 429.

Clock Recovery Algorithm (CRA) 427 is a control loop responsible to calculate the difference between C_{IN} 211 and C_{OUT} 429. The calculation is based on the ability to measure a small deviation, such as 15 PPB within seconds, based on the transmission using the C_{R} in transmitter side device 210. Clock Generator (CG) 428 is responsible to generate C_{OUT} 429 based on internal reference C_{B} and the CRA calculation. CG 428 resolution determines the C_{OUT} accuracy resolution (for example, 15 PPB). The Output Line Interface Unit (OLIU) 426 is responsible to transmit the bit stream generated by SER 425 into the output serial line.

It is to be understood that the phraseology and terminology employed herein are for the purpose of description, and should not be regarded as limiting.

It is important, therefore, that the scope of the invention is not construed as being limited by the illustrative embodiments set forth herein. Other variations are possible within the scope of the present invention as defined in the appended claims and their equivalents.

We claim:

1. A system for synchronizing circuit interfaces for transmitting a serial bit stream in the form of data packets over a packet data network (PDN), the system comprising:
a transmitter side device comprising:
an input clock associated with an input serial line; and
an independent clock C_{IND} operating outside of the valid range of said input clock,
said transmitter side device being responsible:
to receive the data packets via a serial interface comprising data from said input serial line according to said input clock and output the data into a PDN according to said independent clock C_{IND}; and
to control the transmission of said fixed size packets; and
a receiver side device responsible to receive the data packets from the PDN and to release the data packets into an output serial line, according to the difference between said input clock and an output clock (C_{OUT}),
such that small input clock deviations can be accurately detected and adjusted for upon releasing said output bits into said output serial line.

2. A system for synchronizing circuit interfaces for transmitting a serial bit stream in the form of data packets over a packet data network (PDN), the system comprising:
a transmitter side device responsible to receive the data packets via a serial interface comprising data from an input serial line according to an input clock C_{IN} and output the data into a PDN, said transmitter side device comprising:
an input line interface unit (ILIU) responsible to terminate said input serial line and to retrieve both the data packets and the readings of said input clock into said transmitter side device;
a packetizing unit responsible to group the bit stream received by said ILIU into fixed size packets, and release said fixed size packets into the output queue;
an output queue (OUTQ) responsible to store said fixed size packets waiting for transmission to the PDN;
an independent clock C_{IND} operating outside of the valid range of said input clock and responsible to control the transmission of said fixed size packets from said OUTQ to the PDN using the Input Ethernet Controller (IEC); and
an IEC responsible to transmit said fixed size packets to the PDN; and
a receiver side device responsible to receive the data packets from the PDN and to release the data packets into an output serial line, according to the difference between said input clock and an output clock (C_{OUT}), said receiver side device comprising:
an output Ethernet controller responsible to receive the packets from the PDN and to pass on the packets into the jitter buffer queue (JBQ);
a JBQ responsible to store the packets received from the PDN before sending the packets to said output serial line;
a serializer responsible to receive the packets from said JBQ and output the packets as a bit stream into the OLIU using C_{OUT} generated by the Clock Generator (CG) to output bits into the input line interface unit (OLIU);
an internal buffer clock (C_{B}) used as a reference for said CG to generate the value of C_{OUT};
a clock recovery algorithm (CRA) in the form of a control loop responsible to calculate the difference between C_{IN} and C_{OUT} based on the ability to measure a small deviation, based on the transmission using said C_{IND} in said transmitter side device;
a CG responsible to generate said C_{OUT} based on internal reference C_{B} and said CRA calculation, wherein CG resolution determines said C_{OUT} accuracy resolution; and
an OLIU responsible to transmit the bit stream generated by said SER into said output serial line,
such that small input clock deviations can be accurately detected and adjusted for upon releasing said output bits into said output serial line.

3. The system of claim 1, wherein said small measured deviation is 15 parts per billion (PPB).

4. The system of claim 1, wherein said small measured deviation is measured within 5 seconds.

5. The system of claim 1, wherein said small measured deviation is measured within 10 seconds.

6. The system of claim 1, wherein said accuracy resolution of C_{OUT} is 15 parts per billion (PPB).

7. The system of claim 1, wherein said transmitter side comprises hardware and software components.

8. The system of claim 1, wherein said receiver side comprises hardware and software components.

9. The system of claim 1, wherein said small input clock deviations can be accurately detected and adjusted by software.

10. The system of claim 1, wherein said C_{IN} varies up to 50 PPM.

11. A method for synchronizing circuit interfaces for transmitting a serial bit stream from a transmitter side device to a receiver side device in the form of data packets over a PDN, the method comprising:
transmitting a serial bit stream in the form of data packets over a PDN, said transmitting comprising:
receiving the data packets via a serial interface comprising data from an input serial line according to an input clock and output the data into a PDN;
terminating by an input line interface unit (ILIU) of said input serial line and retrieving both the data packets and the readings of said input clock into said transmitter side device;
packetizing the bit stream received by said ILIU into fixed size packets and releasing said fixed size packets into the output queue;
storing by an output queue (OUTQ) of said fixed size packets waiting for transmission to the PDN;
controlling the transmission of said fixed size packets from said OUTQ to the PDN using an Input Ethernet Controller (IEC) by an independent clock C_{IND} operating outside of the valid range of said input clock; and
transmitting by the IEC of said fixed size packets to the PDN; and
receiving the data packets from the PDN and releasing the data packets into an output serial line, according to the difference between said input clock and an output clock (C_{OUT}), said receiving comprising:
receiving by an output Ethernet controller of the packets from the PDN and passing on the packets into a jitter buffer queue (JBQ);
storing by a JBQ of the packets received from the PDN before sending the packets to said output serial line;
receiving by a serializer of the packets from said JBQ and outputting the packets as a bit stream into the OLIU using C_{OUT} generated by the Clock Generator (CG) to output bits into the input line interface unit (OLIU);
generating by an internal buffer clock (C_{B}) used as a reference for said CG of the value of C_{OUT};
calculating the difference between C_{IN} and C_{OUT} by a clock recovery algorithm (CRA) in the form of a control loop, said calculating based on measuring a small deviation and based on the transmission using said C_{IND} in said transmitter side device;
generating by a CG of said C_{OUT} based on internal reference C_{B} and said CRA calculation, wherein CG resolution determines said C_{OUT} accuracy resolution; and
transmitting by an OLIU of the bit stream generated by said SER into said output serial line,
such that small input clock deviations can be accurately detected and adjusted for upon releasing said output bits into said output serial line.

12. A method for synchronizing circuit interfaces for transmitting a serial bit stream from a transmitter side device to a receiver side device in the form of data packets over a PDN, the method comprising:
transmitting a serial bit stream in the form of data packets over a PDN, said method comprising:
receiving the data packets via a serial interface comprising data from an input serial line according to an input clock C_{IN} and output the data into the PDN;
packetizing the bit stream into fixed size packets and releasing said fixed size packets into an output queue; and
controlling the transmission of said fixed size packets by an independent clock C_{IND} operating outside of the valid range of said input clock,
receiving the data packets from the PDN and releasing the data packets into said output queue, according to the difference between said input clock and an output clock (C_{OUT}) having an accuracy resolution,
such that small measured input clock deviation can be accurately detected and adjusted for upon releasing said output bits into said output queue.

13. The method of claim 12, wherein said small measured deviation is 15 parts per billion (PPB).

14. The method of claim 12, wherein said small measured deviation is measured within 5 seconds.

15. The method of claim 12, wherein said small measured deviation is measured within 10 seconds.

16. The method of claim 12, wherein said accuracy resolution of C_{OUT} is 15 parts per billion (PPB).

17. The method of claim 12, wherein said small measured input clock deviation can be accurately detected and adjusted by software.

18. The method of claim 12, wherein said C_{IN} varies up to 50 PPM.
